(19) United States
(12) Patent Application Publication
(10) Pub. No.: US 2018/0230819 A1
(43) Pub. Date: Aug. 16, 2018

(54) TURBINE BLADE HAVING TIP SHROUD RAIL FEATURES

(71) Applicant: General Electric Company, Schenectady, NY (US)

(72) Inventors: William Scott Zemitis, Simpsonville, SC (US); Richard Ryan Pilson, Greer, SC (US); Melbourne James Myers, Woodruff, SC (US)

(21) Appl. No.: 15/431,918

(22) Filed: Feb. 14, 2017

(51) Int. Cl. F01D 5/22; F01D 5/14

(52) U.S. Cl. CPC F01D 5/225; F05D 2240/307; F05D 2220/32; F01D 5/147

(57) ABSTRACT

A turbine blade includes an airfoil that extends from a root end to a tip end, and a tip shroud extending from the tip end. The tip shroud includes a shroud rail that includes a series of regions along a circumferential width of the shroud rail. The series of regions includes a first edge region adjacent to a suction side edge of the tip shroud, and a wide region. A thickness of the wide region is greater than a thickness of the first edge region.

### BACKGROUND OF THE INVENTION

The field of the disclosure relates generally to rotary machines, and more particularly, to a turbine blade having tip shroud rail features.

At least some known rotary machines include a compressor, a combustor coupled downstream from the compressor, a turbine coupled downstream from the combustor, and a rotor shaft rotatably coupled between the compressor and the turbine. Some known turbines include at least one rotor disk coupled to the rotor shaft, and a plurality of circumferentially-spaced turbine blades that extend outward from each rotor disk to define a stage of the turbine. Each turbine blade includes an airfoil that extends radially outward from a platform towards a turbine casing.

At least some known turbine blades include a shroud that extends from an outer tip end of the airfoil to reduce gas flow leakage between the airfoil and the turbine casing. In addition, at least some tip shrouds include circumferentially extending rails on an outer surface of the tip shroud. The rails are shaped to cooperate with, and in some cases to facilitate wear-in of, a mating shroud seal on the adjacent turbine casing.

An operational life cycle of at least some turbine blades may be limited by creep in the shroud and rail regions. Creep is the tendency of a material to deform over time when exposed to a combination of mechanical loading and high temperature. However, design of the rails to reduce mechanical stresses that may lead to creep is limited by a need for the rails to properly distribute stiffness and mass of the tip shroud, in addition to directing combustion gas flow.

In addition, turbine blade creep rate may be greatly impacted by the high temperatures often seen at the shroud. To counter the effects of high temperatures, at least some known turbine blades include an internal cooling circuit, such as an interior tip shroud core cavity, or plenum, and/or passages that run transversely from the plenum toward the outer edges of the shroud. However, such cooling circuits, including tip shroud plenums and cast-in cooling passages, generally increase a complexity and expense of manufacture of the turbine blade, and impose design limits on other properties of the shroud, such as shape and thickness.

### BRIEF DESCRIPTION

In one aspect, a turbine blade is provided. The turbine blade includes an airfoil that extends from a root end to a tip end, and a tip shroud extending from the tip end. The tip shroud includes a shroud rail that includes a series of regions along a circumferential width of the shroud rail. The series of regions includes a first edge region adjacent to a suction side edge of the tip shroud, and a wide region. A thickness of the wide region is greater than a thickness of the first edge region.

In another aspect, a turbine blade is provided. The turbine blade includes an airfoil that extends from a root end to a tip end, and a tip shroud extending from the tip end. The tip shroud includes a shroud rail that includes a series of regions along a circumferential width of the shroud rail. The series of regions includes a first edge region adjacent to a suction side edge of the tip shroud, and a narrow region. A thickness of the first edge region is greater than a thickness of the narrow region.

In another aspect, a turbine blade is provided. The turbine blade includes an airfoil that extends from a root end to a tip end, and a tip shroud extending from the tip end. The tip shroud includes a first shroud rail that includes a first series of regions along a circumferential width of the first shroud rail. The first series of regions includes a first edge region and a wide region. The first edge region of the first series of regions is adjacent to a suction side edge of the tip shroud. A thickness of the wide region is greater than a thickness of the first edge region of the first series of regions. The tip shroud includes a second shroud rail that includes a second series of regions along a circumferential width of the second shroud rail. The second series of regions includes a first edge region and a narrow region. The first edge region of the second series of regions is adjacent to the suction side edge of the tip shroud. A thickness of the first edge region of the second series of regions is greater than a thickness of the narrow region.

### DRAWINGS

FIG. 1 is a schematic view of an exemplary turbine engine assembly;

FIG. 2 is a partial sectional view of a portion of an exemplary rotor assembly that may be used with the turbine engine shown in FIG. 1;

FIG. 3 is a perspective view of a pressure side of an exemplary turbine blade that may be used with the rotor assembly shown in FIG. 2;

FIG. 4 is a perspective view of an exemplary tip shroud that may be used with the turbine blade shown in FIG. 3; and

FIG. 5 is a top view of the exemplary tip shroud shown in FIG. 4.

### DETAILED DESCRIPTION OF THE INVENTION

The exemplary methods and systems described herein overcome at least some disadvantages of known turbine blades by providing a tip shroud that facilitates improving creep performance as compared to known turbine blades. More specifically, the embodiments described herein provide a first tip shroud rail that includes a first series of regions along a circumferential width of the shroud rail. In some embodiments, the first series of regions includes a first edge region adjacent to a suction side edge of the tip shroud, and a wide region. A thickness of the wide region is greater than a thickness of the first edge region. Moreover, in certain embodiments, the first series of regions includes a second edge region adjacent to a pressure side edge of said tip shroud, and a tapered region between the wide region and the second edge region. Additionally or alternatively, the embodiments described herein provide a second tip shroud rail that includes a second series of regions along a circumferential width of the shroud rail. The second series of regions includes a first edge region adjacent to a suction side edge of the tip shroud, and a narrow region. A thickness of the first edge region is greater than a thickness of the narrow region. Moreover, in certain embodiments, the second series of regions includes a second edge region adjacent to a pressure side edge of the tip shroud, and an angled region between the narrow region and the second edge region.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item. As used herein, the term “upstream” refers to a forward or inlet end of a gas turbine engine, and the term “downstream” refers to an aft or nozzle end of the gas turbine engine.

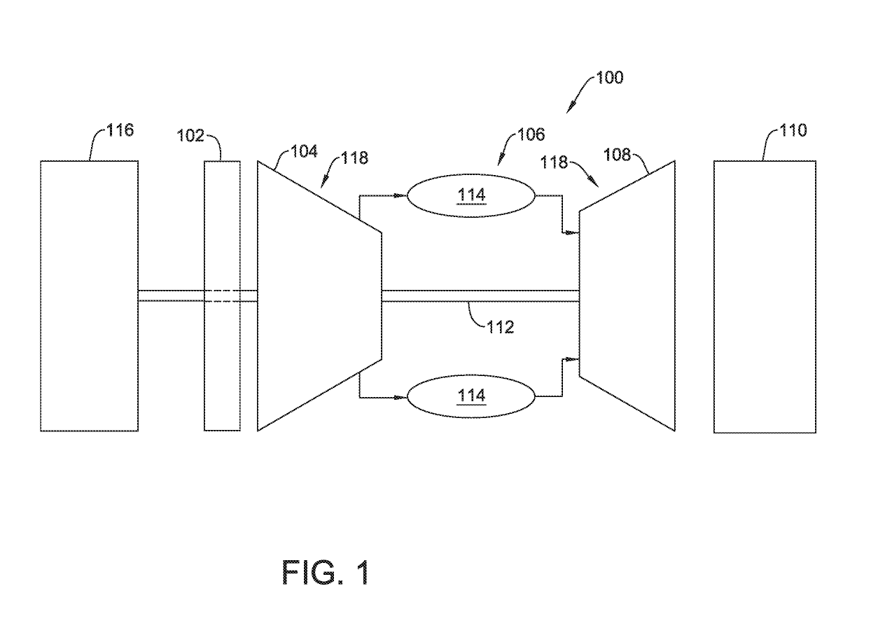

FIG. 1 is a schematic view of an exemplary rotary machine 100, i.e., a turbomachine, and more specifically a turbine engine. In the exemplary embodiment, turbine engine 100 is a gas turbine engine. Alternatively, turbine engine 100 may be any other turbine engine and/or rotary machine, including, without limitation, a steam turbine engine, a gas turbofan aircraft engine, other aircraft engine, a wind turbine, a compressor, and a pump. In the exemplary embodiment, turbine engine system 100 includes an intake section 102, a compressor section 104 that is coupled downstream from intake section 102, a combustor section 106 that is coupled downstream from compressor section 104, a turbine section 108 that is coupled downstream from combustor section 106, and an exhaust section 110 that is coupled downstream from turbine section 108. Turbine section 108 is coupled to compressor section 104 via a rotor shaft 112. In the exemplary embodiment, combustor section 106 includes a plurality of combustors 114. Combustor section 106 is coupled to compressor section 104 such that each combustor 114 is in flow communication with the compressor section 104. Turbine section 108 is further coupled to a load 116 such as, but not limited to, an electrical generator and/or a mechanical drive application. In the exemplary embodiment, each compressor section 104 and turbine section 108 includes at least one rotor assembly 118 that is coupled to rotor shaft 112.

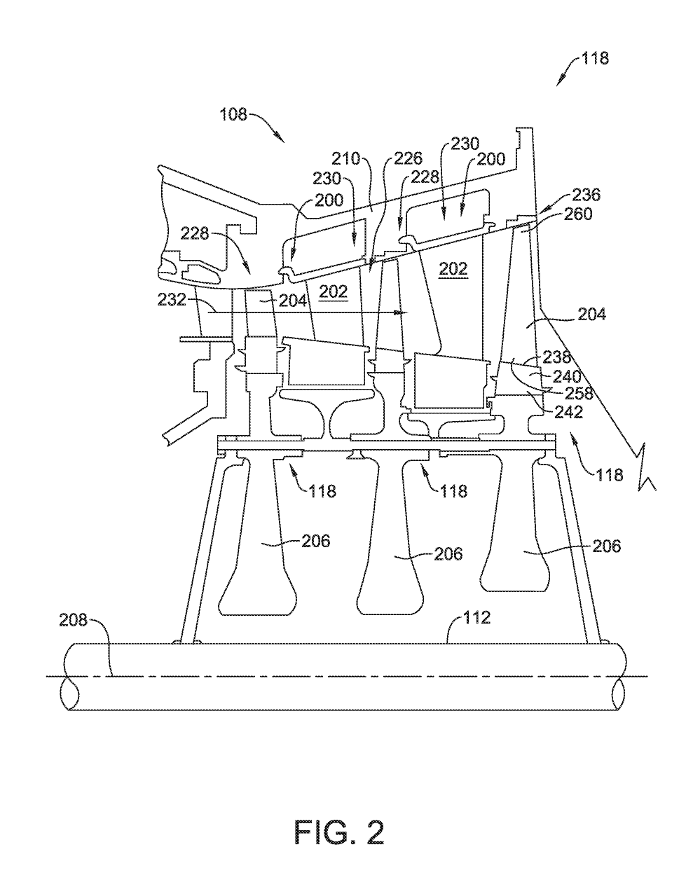

During operation, intake section 102 channels air towards compressor section 104. Compressor section 104 compresses air and discharges compressed air into combustor section 106 and towards turbine section 108 (shown in FIG. 1). The majority of air discharged from compressor section 104 is channeled towards combustor section 106. More specifically, pressurized compressed air is channeled to combustors 114 (shown in FIG. 1) wherein the air is mixed with fuel and ignited to generate high temperature combustion gases. The combustion gases are channeled towards a combustion gas path 232 (shown in FIG. 2), wherein the gases impinge upon turbine blades 204 (shown in FIG. 2) and stator vanes 202 (shown in FIG. 2) of turbine section 108 to facilitate imparting a rotational force on rotor assembly 118. At least a portion of the combustion gas that impinges turbine blades 204, is channeled between a tip shroud 236 (shown in FIG. 2) and turbine casing 210 (shown in FIG. 2).

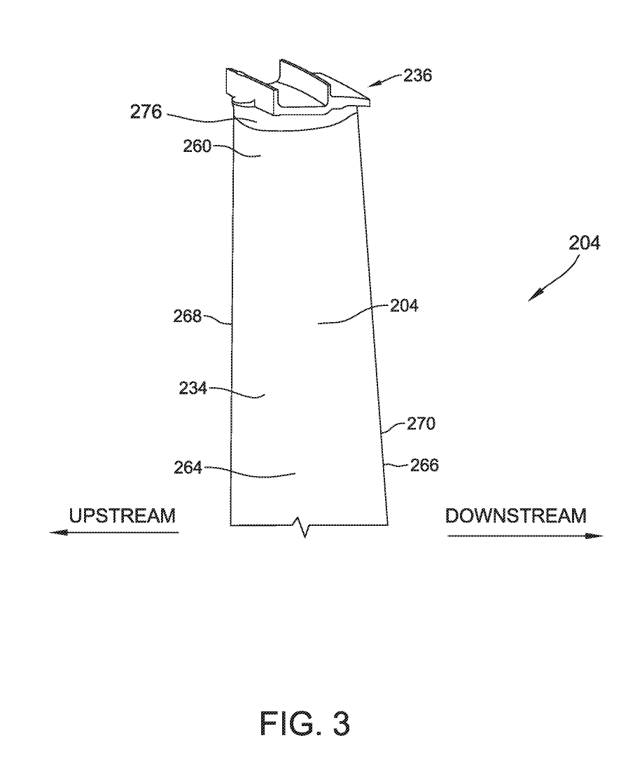

FIG. 2 is a partial sectional view of a portion of an exemplary rotor assembly 118. FIG. 3 is a perspective view of a pressure side 264 of an exemplary turbine blade 204. In the exemplary embodiment, turbine section 108 includes a plurality of stages 200 that each include a stationary row 230 of stator vanes 202 and a corresponding row 228 of rotating turbine blades 204. Turbine blades 204 in each row 228 are spaced-circumferentially about, and each extends radially outward from, a rotor disk 206. Each rotor disk 206 is coupled to rotor shaft 112 and rotates about a centerline axis 208 that is defined by rotor shaft 112. A turbine casing 210 extends circumferentially about rotor assembly 118 and stator vanes 202. Stator vanes 202 are each coupled to turbine casing 210 and each extends radially inward from casing 210 towards rotor shaft 112. A combustion gas path 232 is defined between turbine casing 210 and each rotor disk 206. Each row 228 and 230 of turbine blades 204 and stator vanes 202 extends at least partially through a portion of combustion gas path 232.

In the exemplary embodiment, each turbine blade 204 includes an airfoil 234, a tip shroud 236, a platform 238, a shank 240, and a dovetail 242. Airfoil 234 extends generally radially between platform 238 and tip shroud 236. Tip shroud 236 is positioned adjacent to turbine casing 210. Platform 238 extends between airfoil 234 and shank 240 and is oriented such that each airfoil 234 extends radially outwardly from platform 238 towards turbine casing 210. Shank 240 extends radially inwardly from platform 238 to dovetail 242. Dovetail 242 extends radially inwardly from shank 240 and enables turbine blades 204 to securely couple to rotor disk 206. In the exemplary embodiment, airfoil 234 extends radially between a root end 258, adjacent to platform 238, and a tip end 260.

In the exemplary embodiment, airfoil 234 extends radially between a root end 258, adjacent to platform 238, and a tip end 260, adjacent to tip shroud 236. More specifically, tip shroud 236 extends from tip end 260 of airfoil 234 and between tip end 260 and turbine casing 210 Airfoil 234 has pressure side 264 and an opposite suction side 266. Each side 264 and 266 extends generally axially between a leading edge 268 and a trailing edge 270. Pressure side 264 is generally concave and suction side 266 is generally convex.

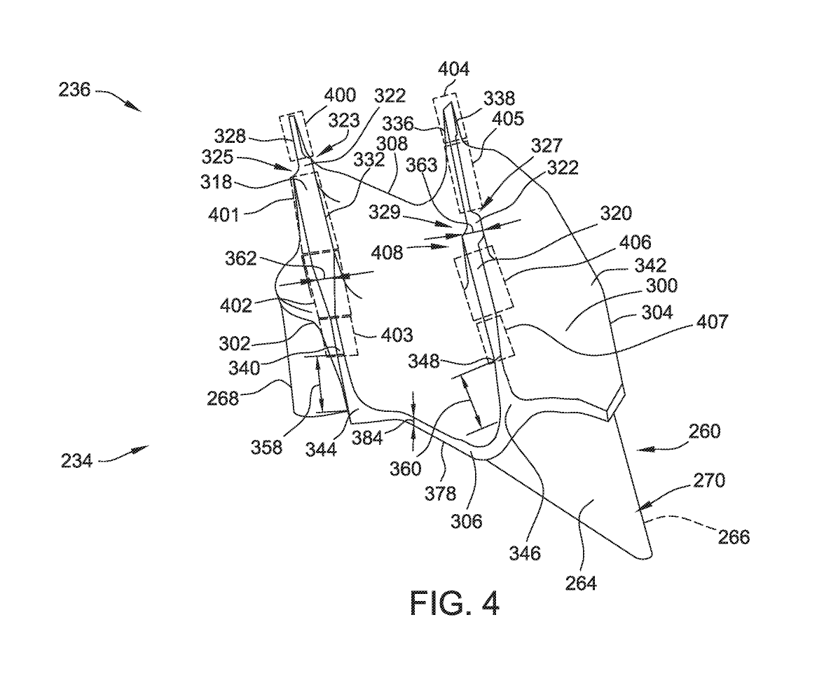

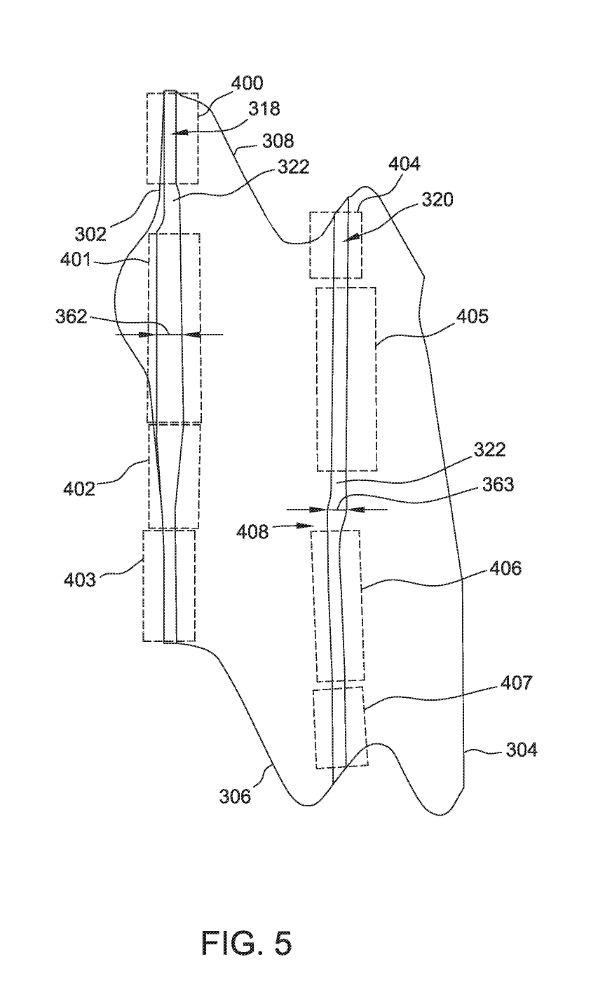

FIG. 4 is a perspective view of an exemplary tip shroud 236. FIG. 5 is a is a top view of exemplary tip shroud 236. In the exemplary embodiment, tip shroud 236 includes a shroud plate 300. Shroud plate 300 is generally rectangular and extends axially between a leading edge 302 and an opposite trailing edge 304, and circumferentially between a first, or pressure side edge 306 and an opposite circumferentially-spaced second, or suction side edge 308. Shroud plate 300 extends radially between an inner surface 378 and an outer surface 342, and has a radial thickness 384 defined therebetween which may vary across shroud plate 300.

In the exemplary embodiment, tip shroud 236 also includes a first shroud rail 318 adjacent leading edge 302, and a second shroud rail 320 spaced axially downstream from first shroud rail 318. In alternative embodiments, tip shroud 236 may include any suitable number of shroud rails. Shroud rails 318 and 320 each extend radially outward from shroud plate 300 towards turbine casing 210 (shown in FIG. 2), and circumferentially between circumferential side edges 306 and 308 of shroud plate 300. For example, in the exemplary embodiment rails 318 and 320 emanate from edge 308 and extend to edge 306. In alternative embodiments, each of rails 318 and 320 emanates at any suitable location on tip shroud plate 300 and/or extends to any suitable extent on tip shroud plate 300 that enables shroud rails 318 and 320 to function as described herein. In some embodiments, shroud rails 318 and 320 are formed separately from, and coupled to, shroud plate 300. In alternative embodiments, shroud rails 318 and 320 are formed integrally with shroud plate 300.

In the exemplary embodiment, each of shroud rails 318 and 320 includes a cutting tooth 322. For example, each cutting tooth 322 is shaped to facilitate creating a respective circumferential groove within a portion of an abradable material (not shown) coupled to turbine casing 210 when turbine engine 100 (shown in FIG. 1) is in operation. In alternative embodiments, at least one of shroud rails 318 and 320 does not include cutting tooth 322.

In the exemplary embodiment, first shroud rail 318 includes a an upstream surface 328, an opposite downstream surface 332, and a thickness 362 defined therebetween. Thickness 362 varies along first shroud rail 318. First shroud rail 318 also extends generally radially outward from a first shroud rail inner end 344, proximate shroud plate outer surface 342, to a first shroud rail outer end 340, and has a first radial height 358 defined therebetween. Upstream surface 328 and downstream surface 332 each extend radially between ends 344 and 340.

Second shroud rail 320 includes second shroud rail upstream surface 336, an opposite second shroud rail downstream surface 338, and a thickness 363 defined between. Thickness 363 varies along second shroud rail 320. Second shroud rail 320 also extends generally radially outward from a second shroud rail inner end 346, proximate shroud plate outer surface 342, to a second shroud rail outer end 348, and has a second radial height 360 defined therebetween. Upstream surface 336 and downstream surface 338 each extend radially between ends 346 and 348.

In certain embodiments, first shroud rail 318 includes a series of regions 400, 401, 402, and 403 along a circumferential width of first shroud rail 318. For example, in the exemplary embodiment, first shroud rail 318 includes a first edge region 400 adjacent to suction side edge 308, and a wide region 401 that extends circumferentially from above suction side 266 of airfoil 234 to above pressure side 264 of airfoil 234. More specifically, wide region 401 has thickness 362 greater than thickness 362 of first edge region 400. For example, thickness 362 varies circumferentially within at least one of first edge region 400 and wide region 401, and thickness 362 across substantially an entirety of wide region 401 is greater than thickness 362 across substantially an entirety of first edge region 400.

Also in the exemplary embodiment, the series of regions along the circumferential width of first shroud rail 318 includes a second edge region 403 adjacent to pressure side edge 306. Wide region 401 has thickness 362 greater than thickness 362 of second edge region 403. For example, thickness 362 varies circumferentially within at least one of second edge region 403 and wide region 401, and thickness 362 across substantially an entirety of wide region 401 is greater than thickness 362 across substantially an entirety of second edge region 403. In some embodiments, thickness 362 of second edge region 403 is substantially equal to thickness 362 of first edge region 400. In alternative embodiments, thickness 362 of second edge region 403 is other than substantially equal to thickness 362 of first edge region 400.

Further in the exemplary embodiment, the series of regions along the circumferential width of first shroud rail 318 includes a tapered region 402 that extends circumferentially between wide region 401 and second edge region 403. More specifically, tapered region 402 extends circumferentially above pressure side 264. In alternative embodiments, tapered region 402 extends circumferentially to any suitable extent that enables tip shroud 236 to function as described herein. Thickness 362 decreases substantially continuously along tapered region 402 from thickness 362 of wide region 401 to thickness 362 of second edge region 403. For example, in the exemplary embodiment, thickness 362 decreases substantially linearly along tapered region 402. In alternative embodiments, thickness 362 decreases substantially continuously along tapered region 402 in any suitable fashion that enables tip shroud 236 to function as described herein.

In the exemplary embodiment, first shroud rail cutting tooth 322 is positioned between first edge region 400 and wide region 401. Thus, in the exemplary embodiment, first shroud rail cutting tooth 322 is positioned above suction side 266 of airfoil 234. In alternative embodiments, first shroud rail cutting tooth 322 is positioned among or between the series of regions 400, 401, 402, and 403 at any suitable location that enables tip shroud 236 to function as described herein.

In certain embodiments, first shroud rail cutting tooth 322 is defined by at least one discontinuous increase in thickness 362 between first edge region 400 and wide region 401. In this context, the term “discontinuous” refers to a transition in thickness that occurs over a very short circumferential distance along the shroud rail, such as along less than about five percent of a circumferential width of the shroud rail. For example, in the exemplary embodiment, cutting tooth 322 is defined by a first discontinuous increase 323 in thickness 362, at which downstream surface 332 transitions axially downstream between first edge region 400 and wide region 401, and a second discontinuous increase 325 in thickness 362, at which upstream surface 328 transitions axially upstream between first edge region 400 and wide region 401. In alternative embodiments, cutting tooth 322 is defined in any suitable fashion that enables first shroud rail 318 to function as described herein.

In certain embodiments, the series of regions 400, 401, 402, and 403 along the circumferential width of first shroud rail 318 facilitates reducing mechanical stresses that may lead to creep in first shroud rail 318, while providing a suitable distribution of stiffness and mass of tip shroud 236 that facilitates stable and effective operation of rotor assembly 118 (shown in FIG. 2). Additionally, the series of regions 400, 401, 402, and 403 provide a suitable interface between end portions of first shroud rail 318 and respective end portions of first shroud rails 318 of adjacent blades 204. Further, the series of regions 400, 401, 402, and 403 facilitate locating first shroud rail cutting tooth 322 adjacent a relatively narrow portion of first shroud rail 318, such that cutting tooth 322 projects sufficiently from the shroud rail to efficiently form a circumferential groove within a portion of an abradable material (not shown) coupled to turbine casing 210 (shown in FIG. 2) when turbine engine 100 (shown in FIG. 1) is in operation. Moreover, in some embodiments, the reduction in mechanical stresses in first shroud rail 318 sufficiently limits creep such that a tip shroud plenum or cast-in tip shroud cooling passages (not shown) are not needed for blade 204.

Also, in certain embodiments, second shroud rail 320 includes a series of regions 404, 405, 406, and 407 along a circumferential width of second shroud rail 320. For example, in the exemplary embodiment, second shroud rail 320 includes a first edge region 404 adjacent to suction side edge 308, and a narrow region 405 that extends circumferentially substantially above suction side 266 of airfoil 234. More specifically, first edge region 404 has thickness 363 greater than thickness 363 of narrow region 405. For example, thickness 363 varies circumferentially within at least one of first edge region 404 and narrow region 405, and thickness 363 across substantially an entirety of first edge region 404 is greater than thickness 363 across substantially an entirety of narrow region 405.

Also in the exemplary embodiment, the series of regions along the circumferential width of second shroud rail 320 includes a second edge region 407 adjacent to pressure side edge 306. In some embodiments, thickness 363 of second edge region 407 is substantially equal to thickness 363 of first edge region 404. In alternative embodiments, thickness 363 of second edge region 407 is other than substantially equal to thickness 363 of first edge region 404.

Further in the exemplary embodiment, the series of regions along the circumferential width of second shroud rail 320 includes an angled region 406 that extends circumferentially between narrow region 405 and second edge region 407. More specifically, angled region 406 extends substantially above pressure side 264. In alternative embodiments, angled region 406 extends circumferentially to any suitable extent that enables tip shroud 236 to function as described herein. Angled region 406 transitions axially downstream from a first end 408, substantially above a cross-sectional area of tip end 260 of airfoil 234, to second edge region 407. For example, in the exemplary embodiment, angled region 406 slopes substantially linearly downstream between first end 408 and second edge region 407. In alternative embodiments, angled region 406 transitions downstream between first end 408 and second edge region 407 in any suitable fashion that enables tip shroud 236 to function as described herein.

In the exemplary embodiment, second shroud rail cutting tooth 322 is positioned between narrow region 405 and angled region 406. Thus, in the exemplary embodiment, second shroud rail cutting tooth 322 is positioned substantially above a cross-sectional area of tip end 260 of airfoil 234. In alternative embodiments, second shroud rail cutting tooth 322 is positioned among or between the series of regions 404, 405, 406, and 407 at any suitable location that enables tip shroud 236 to function as described herein.

In certain embodiments, second shroud rail cutting tooth 322 is defined by at least one discontinuous increase in thickness 363 between narrow region 405 and angled region 406, similar to as described above for first shroud rail cutting tooth 322. For example, in the exemplary embodiment, second shroud rail cutting tooth 322 is defined by a first discontinuous increase 327 in thickness 363, at which downstream surface 338 transitions axially downstream between narrow region 405 and angled region 406, and a second discontinuous increase 329 in thickness 363, at which upstream surface 336 transitions axially upstream between narrow region 405 and angled region 406. In alternative embodiments, cutting tooth 322 is defined in any suitable fashion that enables second shroud rail 320 to function as described herein.

In the exemplary embodiment, first end 408 of angled region 406 is coupled to cutting tooth 322, such that angled region 406 transitions axially downstream from second shroud rail cutting tooth 322 to second edge region 407. More specifically, angled region 406 emanates from an axially upstream portion of second shroud rail cutting tooth 322, and the axially upstream portion is not axially aligned with edge regions 404 and 407. Thus, angled region 406 transitions downstream from second shroud rail cutting tooth 322 to interface with second edge region 407, facilitating alignment of second edge region 407 with first edge region 404 of an adjacent tip shroud 236.

In certain embodiments, the series of regions 404, 405, 406, and 407 along the circumferential width of second shroud rail 320 facilitates reducing mechanical stresses that may lead to creep in second shroud rail 320, while providing a suitable distribution of stiffness and mass of tip shroud 236 that facilitates stable and effective operation of rotor assembly 118 (shown in FIG. 2). Additionally, the series of regions 404, 405, 406, and 407 provide a suitable interface between end portions of second shroud rail 320 and respective end portions of second shroud rails 320 of adjacent blades 204. Further, the series of regions 404, 405, 406, and 407 facilitate locating second shroud rail cutting tooth 322 adjacent a relatively narrow portion of second shroud rail 320, such that cutting tooth 322 projects sufficiently from the shroud rail to efficiently form a circumferential groove within a portion of an abradable material (not shown) coupled to turbine casing 210 (shown in FIG. 2) when turbine engine 100 (shown in FIG. 1) is in operation. Moreover, in some embodiments, the reduction in mechanical stresses in second shroud rail 320 sufficiently limits creep such that a tip shroud plenum or cast-in tip shroud cooling passages (not shown) are not needed for blade 204.

The above-described embodiments overcome at least some disadvantages of known turbine blades by providing a tip shroud that improves creep performance. More specifically, the embodiments described herein provide a series of regions along a circumferential width of a shroud rail. Specifically, a relative axial thickness of some regions in the series is selected to facilitate reducing mechanical stresses that may lead to creep in the shroud rail, while providing a suitable distribution of stiffness and mass of the tip shroud to facilitate stable and effective operation of a rotor assembly. Also specifically, in some embodiments, one of the regions has a tapered thickness or transitions axially downstream to further facilitate reducing mechanical stresses that may lead to creep in the shroud rail, while providing a suitable distribution of stiffness and mass of the tip shroud to facilitate stable and effective operation of a rotor assembly. Also specifically, in some embodiments, the series of regions of the tip shroud rail facilitate a reduction in mechanical stresses that sufficiently limits creep such that a tip shroud plenum or cast-in tip shroud cooling passages are not needed, reducing a cost of manufacture of the turbine blade.

Exemplary embodiments of a tip shroud for use on a turbine blade are described above in detail. The disclosure is not limited to the specific embodiments described herein, but rather, components may be utilized independently and separately from other components described herein. For example, the apparatus may also be used in combination with other rotary machines, and are not limited to practice with only the gas turbine engine assembly as described herein. Rather, the exemplary embodiment may be implemented and utilized in connection with many other applications.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine blade comprising:
an airfoil that extends from a root end to a tip end; and
a tip shroud extending from said tip end, said tip shroud comprising a shroud rail, said shroud rail comprising a series of regions along a circumferential width of said shroud rail, said series of regions comprising:
a first edge region adjacent to a suction side edge of said tip shroud; and
a wide region, wherein a thickness of said wide region is greater than a thickness of said first edge region.

2. The turbine blade in accordance with claim 1, wherein said shroud rail is adjacent to a leading edge of said airfoil.

3. The turbine blade in accordance with claim 1, wherein said wide region extends circumferentially from above a suction side of said airfoil to above a pressure side of said airfoil.

4. The turbine blade in accordance with claim 1, wherein said series of regions further comprises a second edge region adjacent to a pressure side edge of said tip shroud, and wherein said thickness of said wide region is greater than a thickness of said second edge region.

5. The turbine blade in accordance with claim 4, wherein said thickness of said second edge region is substantially equal to said thickness of said first edge region.

6. The turbine blade in accordance with claim 4, wherein said series of regions further comprises a tapered region between said wide region and said second edge region, a thickness of said tapered region decreases substantially continuously along said tapered region between said wide region and said second edge region.

7. The turbine blade in accordance with claim 6, wherein said thickness of said tapered region decreases substantially linearly along said tapered region.

8. The turbine blade in accordance with claim 1, wherein a cutting tooth is positioned between said first edge region and said wide region.

9. The turbine blade in accordance with claim 1, wherein said shroud rail comprises a first shroud rail, said tip shroud further comprises a second shroud rail spaced axially downstream from said first shroud rail.

10. A turbine blade comprising:
an airfoil that extends from a root end to a tip end; and
a tip shroud extending from said tip end, said tip shroud comprising a shroud rail, said shroud rail comprising a series of regions along a circumferential width of said shroud rail, said series of regions comprising:
a first edge region adjacent to a suction side edge of said tip shroud; and
a narrow region, wherein a thickness of said first edge region is greater than a thickness of said narrow region.

11. The turbine blade in accordance with claim 10, wherein said shroud rail is spaced downstream from a leading edge of said airfoil.

12. The turbine blade in accordance with claim 10, wherein said narrow region extends circumferentially substantially above a suction side of said airfoil.

13. The turbine blade in accordance with claim 10, wherein said series of regions further comprises a second edge region adjacent to a pressure side edge of said tip shroud, and wherein said thickness of said first edge region is substantially equal to a thickness of said second edge region.

14. The turbine blade in accordance with claim 13, wherein said series of regions further comprises an angled region between said narrow region and said second edge region, said angled region transitions axially downstream from a first end of said angled region to said second edge region.

15. The turbine blade in accordance with claim 14, wherein said angled region slopes substantially linearly downstream between said first end and said second edge region.

16. The turbine blade in accordance with claim 14, wherein a cutting tooth is positioned between said narrow region and said angled region.

17. The turbine blade in accordance with claim 10, wherein said shroud rail comprises a second shroud rail, said tip shroud further comprises a first shroud rail adjacent a leading edge of said airfoil.

18. A turbine blade comprising:
an airfoil that extends from a root end to a tip end; and
a tip shroud extending from said tip end, said tip shroud comprising:
a first shroud rail comprising a first series of regions along a circumferential width of said first shroud rail, said first series of regions comprising a first edge region and a wide region, said first edge region of said first series of regions is adjacent to a suction side edge of said tip shroud, wherein a thickness of said wide region is greater than a thickness of said first edge region of first series of regions; and
a second shroud rail comprising a second series of regions along a circumferential width of said second shroud rail, said second series of regions comprising a first edge region and a narrow region, said first edge region adjacent to said suction side edge of said tip shroud, wherein a thickness of said first edge region of said second series of regions is greater than a thickness of said narrow region.

19. The turbine blade in accordance with claim 18, wherein said first series of regions further comprises:
a second edge region adjacent to a pressure side edge of said tip shroud; and
a tapered region between said wide region and said second edge region of said first series of regions, a thickness of said tapered region decreases substantially continuously along said tapered region between said wide region and said second edge region of said first series of regions.

20. The turbine blade in accordance with claim 18, wherein said second series of regions further comprises:
a second edge region adjacent to a pressure side edge of said tip shroud; and
an angled region between said narrow region and said second edge region of said second series of regions, said angled region transitions axially downstream from a first end of said angled region to said second edge region of said second series of regions.
